(19) United States
(12) Patent Application Publication
(10) Pub. No.: US 2007/0001333 A1
(43) Pub. Date: Jan. 4, 2007

(54) System and method for forming textured polymeric films

(76) Inventors: Ashwit Dias, Goa (IN); Hari Krishna Harikumar, Bangalore (IN); Narasimha Acharya, Bangalore (IN); Sanjog Shyam Jain, Pune (IN); Mahendra Madhukar Patil, Bangalore (IN); Shailendra Pramod Joshi, Pune (IN); Robert Lawrence Tatterson, Evansville, IN (US)

Correspondence Address: Patrick S. Yoder;FLETCHER YODER, P.O. Box 692289, Houston, TX, 77269-2289, US

(21) Appl. No.: 11/172,746

(22) Filed: Jun. 30, 2005

(51) Int. Cl. B29C 59/04; B29C 47/92

(52) U.S. Cl. 264/40.6; 264/210.2; 264/284; 425/363

(57) ABSTRACT

An apparatus and method for forming a textured polymeric film are disclosed. The apparatus includes a first roller and a second roller, wherein the first roller and the second roller may be configured to cooperatively form the textured polymeric film. In one embodiment, a limited portion of at least the first roller is heated, passively, actively, or by a combination of active and passive techniques.

### BACKGROUND

The invention relates generally to the formation of polymeric films and, more specifically, to the formation of textured polymeric films using roller assemblies.

Textured polymeric films are formed using polymeric substrate or melt. Polymeric substrates typically refer to matrix resins used as raw material for forming the textured polymeric film using calendaring process. In a typical calendaring or embossing process, rollers are used to process a polymeric substrate, such as a polymeric melt or film, to form a textured film. For example, a polymeric substrate may be provided to a nip region formed by two rotating rollers. As the polymeric substrate passes between the rollers, the cooling and pressure provided by the rollers results in a film of the desired thickness emerging from the roller assembly. In addition, if one or both rollers have a textured surface, the emergent film may also be textured.

For example, in a conventional calendaring process, the polymeric substrate enters the nip region at a temperature above its glass transition temperature (Tg) such that it is malleable and impressionable. For semi-crystalline polymers the polymeric substrate would have to be above its melt transition temperature (Tm). The rollers are maintained at a temperature below the glass transition temperature (or melt transition temperature where appropriate) of the substrate. Therefore, as the substrate proceeds through the rollers it is subjected to both pressure and cooling, which imprints the texture onto the film and sets the film. The textures imprinted onto the film are largely a function of the material properties of the film and of the temperatures and pressures experienced by the film while it is within the nip region.

In particular, the roll coolant temperature and film or melt temperature typically determine the fidelity with which textures are imprinted onto the emergent film. For example, too rapid cooling of the film by the rollers may result in poor fidelity between the texture of the film and the texture of the roller surface, such as in terms of shape, size, depth, etc. Furthermore, too rapid cooling of the film by the rollers may result in premature setting of the emergent films, thereby resulting in an emergent film having high internal stress. On the other hand, if one sets the roller temperatures higher than the Tg of the polymeric substrate, or cools the film too slowly, the emergent film will not cool to the required temperature for setting the textures in and will experience an elastic spring back as the pressure decrease and the films emerges from the nip region. Both the lack of texture fidelity and the high internal stress of the emergent film may make the film undesirable or less desirable for its intended applications.

There is, accordingly, a need to provide an improved mechanism to control the transient temperature gradient of the polymeric films so as to optimize the flow of pre-heated films for having better control on replication of the textures of the rollers on the films.

### BRIEF DESCRIPTION

In accordance with an exemplary embodiment of the present technique, an apparatus for forming a textured polymeric film is disclosed. The apparatus includes a first roller and a second roller configured to cooperatively form a textured polymeric film. The apparatus further includes a heating component configured to heat at least a limited portion of the first roller.

In accordance with another embodiment of the present technique, a control system for monitoring and controlling various operating parameters of an apparatus for forming a textured polymeric film is disclosed. The control system includes a first roller and a second roller configured to form a textured polymeric film. The control system also includes a heating component configured to heat at least a limited portion of one of the first and second rollers and a temperature sensing device adapted to measure the temperature of at least one of the first roller of the textured polymeric film, or of a polymeric substrate from which the textured polymeric film is formed. Additionally, the control system further includes a cooling system configured to cool at least one of the first and second rollers and a roller drive system configured to drive at least one of the first and second rollers. Finally, the control system includes a controller configured to control at least one of the heating components, the cooling system, or the roller drive system based on an output of the temperature sensing device.

In accordance with yet another embodiment of the present technique, a method for forming a textured polymeric film is disclosed. The method includes providing a polymeric substrate to a roller assembly, wherein the roller assembly includes a first roller and a second roller and wherein the polymeric substrate is formed into a textured polymeric film upon passing through the roller assembly. The method also includes heating at least a limited portion of the first roller.

In accordance with an embodiment of the present technique, a roller for use in a calendaring process is disclosed. The roller includes a surface material having a thermal conductivity of less that 15 Watts per meter Kelvin at a surface configured to contact a polymeric substrate.

In accordance with an embodiment of the present technique, a roller for use in a calendaring process is disclosed. The roller includes one or more layers configured to provide different thermal properties. In a specific embodiment, a surface layer has lower thermal diffusivity than an interior layer of the roller.

### DRAWINGS

These and other features, aspects, and advantages of the present invention will become better understood when the following detailed description is read with reference to the accompanying drawings in which like characters represent like parts throughout the drawings, wherein:

FIG. 1 is a graphical depiction illustrating an effect of peak roller surface temperature in the nip region on the replication of a polymeric film, in accordance with one embodiment of the present technique;

FIG. 2 is a graphical depiction illustrating an effect of surface thermal conductivity on the replication depth of a roller surface in a polymeric film, in accordance with one embodiment of the present technique;

FIG. 3 is a depiction of a typical apparatus for forming a textured polymeric film;

FIG. 4 is a depiction of a diametrical cross-section of an exemplary textured surface of a roller for forming a textured polymeric film by the process of FIG. 3, in accordance with one embodiment of the present technique;

FIG. 5 is a depiction of another exemplary textured surface of a roller for forming a textured polymeric film by the process of FIG. 3, in accordance with one embodiment of the present technique;

FIG. 6 is a depiction of the use of coatings included on a roller used in the process depicted in FIG. 3, in accordance with one embodiment of the present technique;

FIG. 7 is a depiction of the use of coatings included on a roller used in the process depicted in FIG. 3, in accordance with another embodiment of the present technique;

FIG. 8 is a depiction of the use of coatings included on a roller used in the process depicted in FIG. 3, in accordance with yet another embodiment of the present technique;

FIG. 9 is a depiction of an exemplary apparatus for forming a textured polymeric film using structures conductive to eddy current heating embedded on a roller and induction heating coils placed in proximity of the surface of at least one of the rollers, in accordance with one embodiment of the present technique;

FIG. 10 is a depiction of an exemplary apparatus for forming a textured polymeric film using resistive heaters embedded on one or more rollers, in accordance with one embodiment of the present technique;

FIG. 11 is a depiction of an exemplary apparatus for forming a textured polymeric film using a radiation heating component disposed proximate to a roller, in accordance with one embodiment of the present technique;

FIG. 12 is a depiction of an exemplary apparatus for forming a textured polymeric film using a radiation heating component disposed away from a roller, in accordance with one embodiment of the present technique;

FIG. 13 is a depiction of an exemplary apparatus for forming a textured polymeric film using a radiation heating component in conjunction with a reflector configured for directing radiation on a roller, in accordance with one embodiment of the present technique;

FIG. 14 is a depiction of an exemplary apparatus for forming a textured polymeric film using multiple radiation heating components configured for heating a limited portion of the rollers, in accordance with one embodiment of the present technique;

FIG. 15 is a depiction of an exemplary apparatus for forming a textured polymeric film using a radiation heating component configured for heating the film directly, in accordance with one embodiment of the present technique;

FIG. 16 is a depiction of an exemplary apparatus for forming a textured polymeric film using a radiation heating component and sensing devices disposed around the apparatus for sensing various operating parameters of the apparatus, in accordance with one embodiment of the present technique; and

FIG. 17 is a diagrammatic depiction of a control system for sensing various operating parameters of an exemplary apparatus for forming a textured polymeric film, in accordance with one embodiment of the present technique.

### DETAILED DESCRIPTION

The preceding discussion relates generally to calendaring systems and control mechanisms configured to control the transient temperatures experienced by a polymeric substrate during the calendaring process.

The various implementations discussed herein are generally adapted to improve texture replication fidelity in polymeric films formed via the calendaring processes. As will be appreciated by persons skilled in the art, the calendaring process is used to form textured polymeric films using calendaring rollers. The present techniques provide control of the transient temperatures experienced by a polymeric substrate in the nip region formed by two rollers, thereby allowing improved texture replication fidelity and/or reducing the internal stress of the resulting film. For example, the temperature of the surface of one or more of the calendaring rollers may be increased as they approach a nip region. This controls or even stops the cooling process and produces the textured polymeric film having high fidelity texture replication relative to the imprinting surface and reduced internal stress.

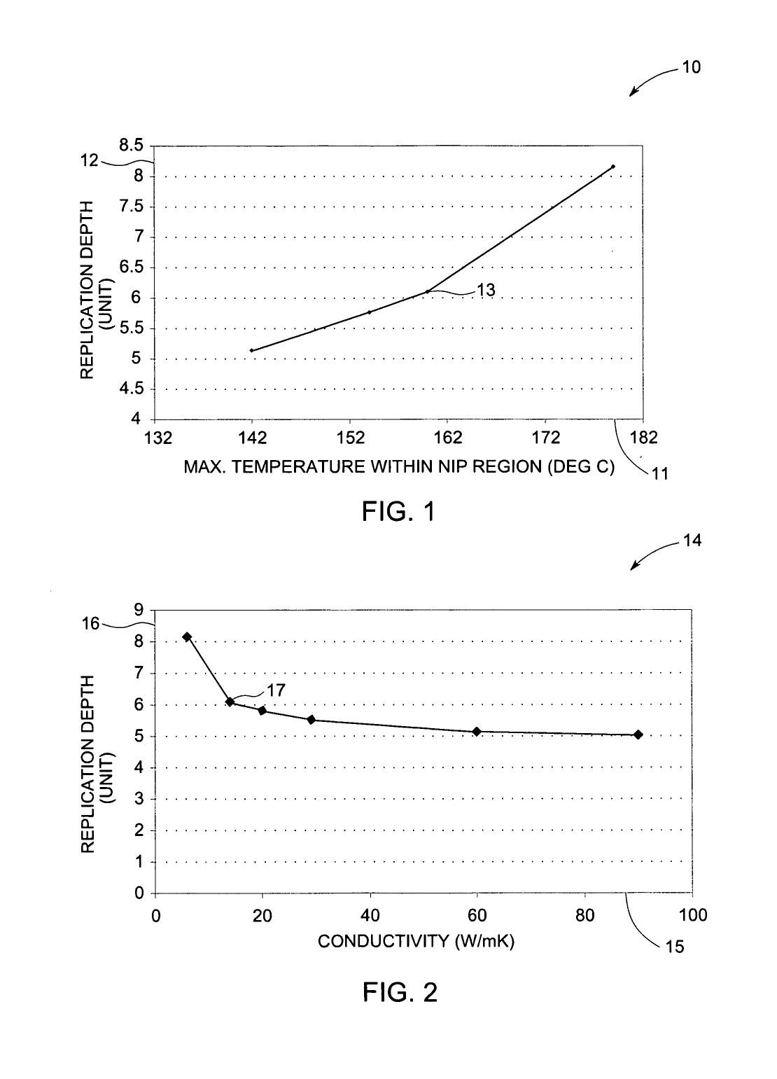

In order to understand and appreciate the various aspects of the present technique, the following sections provide a brief introduction to the thermal environment and variables affecting the formation of textured films. In particular, FIG. 1 graphically depicts an effect 10 of the peak transient temperature on the replication of the roller surface on the textured polymeric film formed by a calendaring process. More particularly, the graphical illustration explains a relation between maximum temperature on the roller surface in the nip region 11 and the replication depth in the textured film 12. Replication depth may be defined as the depth of replication of the roller pattern on the polymeric substrate. As illustrated, as the maximum temperature in the nip region increases, the replication depth also increases monotonically. However, after a certain increase in temperature as indicated by reference numeral 13, a non-linear increase in the replication depth may occur above a certain temperature. Therefore, transient temperature of the film in the nip region is one of the variables affecting the uniformity and fidelity of pattern replication on the polymeric film. Therefore, it may be desirable to maintain the polymeric film surface at a temperature higher than its Tg for as long a period as possible within the nip region, while at the same time ensuring that the film cools to below its Tg before it exits the nip region of the process to prevent spring back and loss of replication.

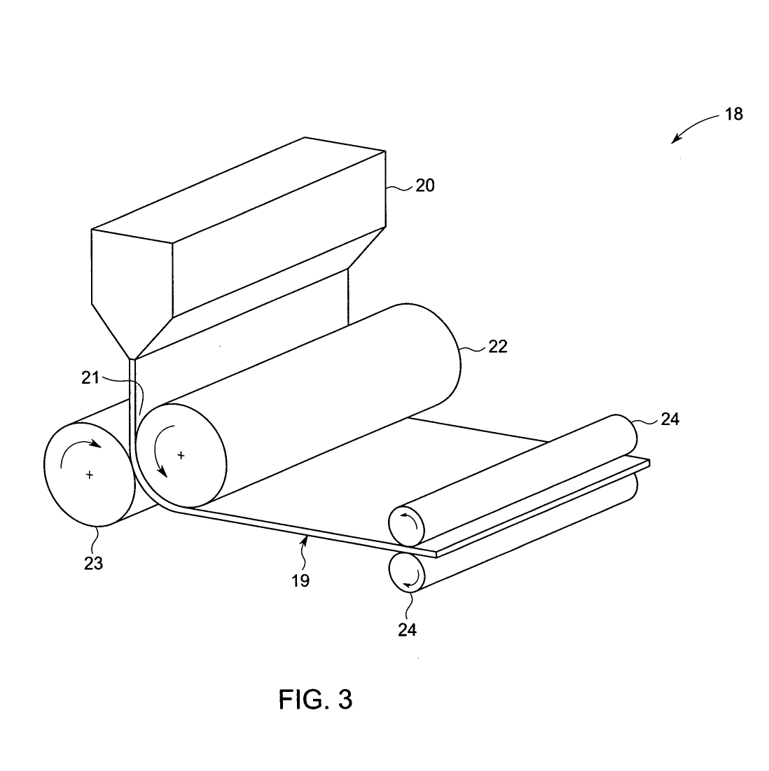

Similarly, FIG. 2 depicts the effect 14 of surface thermal conductivity 15 of a roller surface on the replication depth 16 in a polymeric film. As illustrated, as the thermal conductivity of the coated layer on the roll decreases, the replication depth on the polymer increases. Below a particular value as indicated by reference numeral 17, a significant increase is observed in the replication depth 16. Therefore, the thermal conductivity of the roller surface is another variable affecting the uniformity and fidelity of pattern replication on the polymeric film.

Keeping in mind the preceding discussion, FIG. 3 depicts a typical apparatus 18, for forming a textured polymeric film 19 in accordance with the present invention. The depicted apparatus includes an extruder 20 containing polymeric substrate. The polymeric substrate is extruded into a nip region 21 formed between a first roller 22 and a second roller 23. The first roller 22 and the second roller 23 may be referred to jointly as a roller assembly. A pattern on the surface of the first and/or the second rollers (22 and 23) is replicated on the polymeric substrate to form the textured polymeric film 19. In the depicted embodiment, a different set of rollers 24 is provided subsequent to the first and second rollers (22 and 23) to provide flatness, edge curl and bagginess as specified for the textured polymeric film 19.

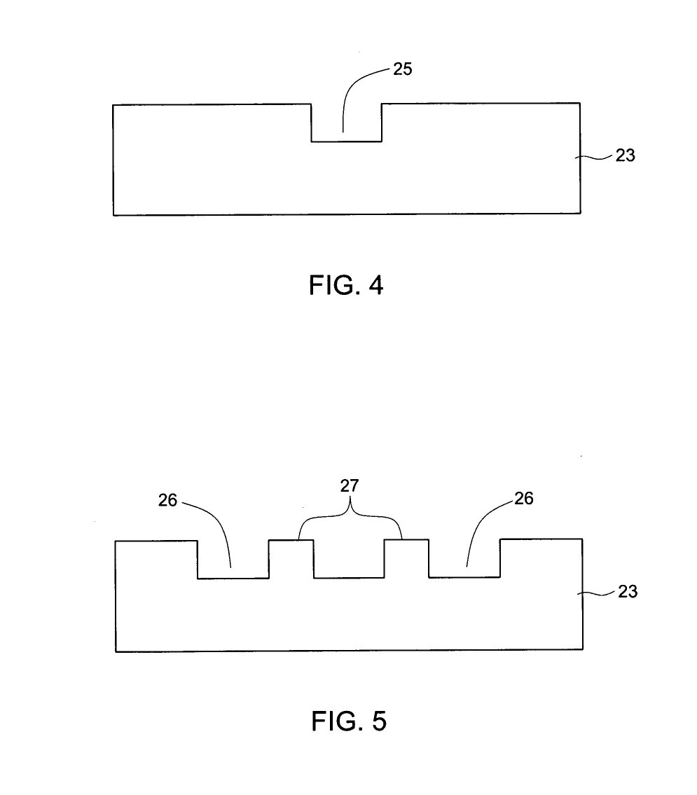

FIG. 4 depicts the surface of a roller, such as roller 23, having an exemplary texture 25 to be replicated on a textured polymeric film produced by the process of FIG. 3, in accordance with one embodiment of the present technique. In the illustrated embodiment, the texture represented by reference numeral 25, is formed on one or both of the first roller or the second roller.

FIG. 5 depicts another exemplary texture 26 used on the surface of a roller, such as the roller 23, for forming a textured polymeric film by the process of FIG. 3, in accordance with one embodiment of the present technique. As illustrated, additional texture or surface features may be provided on the roller surface, which serve to decrease the thermal diffusivity (or conductivity) of the system. In, particular, the regions in contact with the polymeric substrate are pathways 27 for heat transfer. By designing the roller pattern such that the contact regions between the polymeric substrate and the roller are minimized, one can reduce heat transfer and the cooling of the polymeric substrate within the nip region 21. For example,—if one were to replicate the rectangular feature of FIG. 4 and the features in FIG. 5, with other processing conditions remaining the same, the features replicated using the texture 26 of FIG. 5 would replicate with greater fidelity than comparable features replicated using the texture 25 of FIG. 4. This is because the pathways 27 for heat transfer are narrower in FIG. 5, providing the roller having the surface texture 26 with a lower thermal mass at the surface. In general, the texture 26 may be shaped or selected to provide a desired thermal mass at the surface for the respective roller, thereby controlling the profile that the substrate assumes as it solidifies. It should be noted that though reference is made to the texture being formed on the second roller 23, the texture may also be formed on the first roller and multiple rollers.

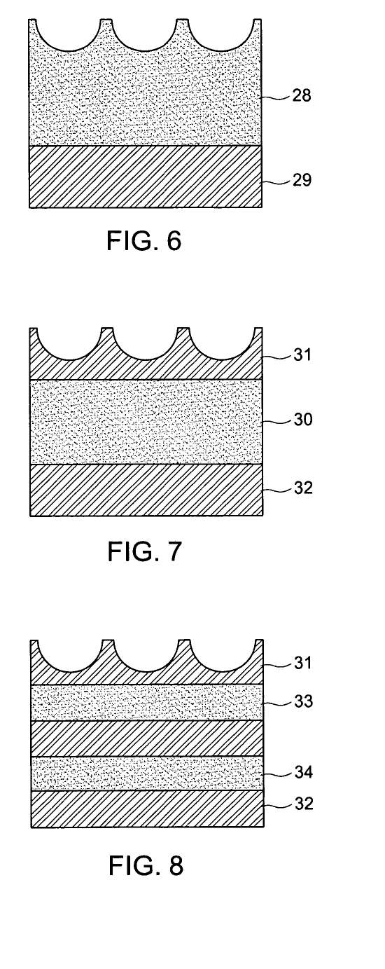

FIG. 6 depicts the use of a coating 28 on the surface of a roller, such as roller 22 or 23, in accordance with one embodiment of the present technique. In the illustrated embodiment, the coating 28 provides a coat on a base material 29 to form the surface of the roller. In one embodiment, the base material 29 includes one or more of chromium, nickel, steel or alloys/oxides of these materials, though other base materials may be employed in accordance with the present technique. In one embodiment, the coating 28 is a low conductivity material that can give significant improvements to the replication of the roller pattern on the polymeric film. Materials for coating may include, but are not limited to, ferric oxide, nickel chromium alloys, oxides of chromium and zirconium or combinations thereof.

The thermal conductivity value of the coating 28 is desired to be less than 15 Watts per meter Kelvin (W/m K) of the roller coating. In some embodiments, the conductivity of the coating can also be reduced by providing pores in the coating, i.e., by having a porous coating, as discussed below. In such embodiments, the effective conductivity of the coating 28, not merely the conductivity of the coating material, may be of primary interest. In one implementation of the present technique, the thickness of coating may be in the range of about 25 microns to about 500 microns.

In some embodiments, the coating 28 acts as a thermal barrier to the heat flux, thereby slowing or reducing the cooling of the polymeric substrate within the nip region. The properties of the coating 28 along with the thickness of the coating 28 define the temperatures seen by the film within the nip region 21. However, as noted above, for maximum replication, one needs to ensure that the film is cooled to below its Tg before it exits the nip region.

In yet another implementation of the present technique, the surface material of the first roller may include a porous material for controlling the heat flux. The porous material will typically have a thermal conductivity value smaller than that of bulk material, and effectively reduces heat transfer in order to achieve the desired thermal gradient within the polymeric substrate and the roller material. For example, the surface materials include but are not limited to oxides, carbides, nitrides or borides of aluminum, titanium, silicon, magnesium, chromium or zirconium. It should be noted that though reference is made to the above-mentioned materials, any other material including alloys suitable for this art, might also be used in the certain implementations of the present technique. While the preceding discussion only references characteristics or compositions of the surface of the first roller 22 to lower thermal mass of the surface, one of ordinary skill in the art will appreciate, that the same or similar techniques may be employed with both the first and second rollers 22 and 23 to improve the performance of the calendaring system 18 as a whole.

In one embodiment, the textured surface of the first roller 22 has a low thermal diffusivity, allowing the surface of the first roller 22 to maintain a higher temperature for a longer period when interacting with the polymeric substrate. Thermal diffusivity represents the ability of a material to conduct heat, higher the thermal diffusivity of the roller surface, the higher will be the rate of cooling of the polymer melt. In one embodiment, in order to achieve the low thermal diffusivity and to control heat flux in the polymeric films, the first roller includes a surface material having one or more material properties providing a low thermal diffusivity.

The surface material of the roller in this case also acts as a heat barrier, which helps to keep the polymer at a higher temperature for a longer time compared to that of a standard roller without the above-mentioned coatings. The thermal barrier also helps to reduce the stress in the roller and to have a temperature profile such that a suitable profile may be selected depending on the requirement of the system. The surface materials may include but are not limited to oxidized ferrous, nickel, chromium or copper alloy, ceramics, or combinations thereof. As mentioned above, certain alloys known in the art may also be used for similar implementation of the present technique.

FIG. 7 depicts the use of a barrier layer 30 as part of a roller, such as roller 22 or 23, in accordance with another embodiment of the present technique. It should be noted that one of the significant challenges in calendaring system is the rapid cooling rates that are experienced by the rollers. Therefore, there is a need to either heat the roller to a large temperature such that the decay of the temperature over time may be neglected or to provide a heating component proximate to the rollers or the polymeric substrate. However, space constraints make the positioning of the heating component difficult at times. Also, excessive heating may start to affect the cooling capacity of the roller and its steady state temperature. In light of this scenario, it is proposed to have a layered configuration or composition of the roller or rollers. The depth and material of this layer is optimized based on the requirement of the application. The layer acts as a damper to the heat flux, resulting in the skin of the roller remaining hotter for a longer period of time. In this manner it is also possible to heat the skin of the roller to a higher temperature, which would be otherwise not possible. This allows additional flexibility in the positioning of the heating component as well as the power outputs that might be required from such heating components.

In the illustrated embodiment of FIG. 7, the barrier layer 30 is provided between a surface layer 31 and the core 32 of the roller. In one embodiment, the surface layer 31 and the core 32 are formed from the same base material. This allows the use of a material, such as steel, as a core 32 and surface layer 31 of the roller. For example, such a steel (or other base material) surface layer 31 may be textured using laser engraving, etching (dry/wet), blasting, micro machining, electroforming/plating, and lithographic techniques. In other embodiments, the surface layer 31 and the core 32 are formed from different materials. In either embodiment, the barrier layer 30 acts as a thermal barrier for the heat flux, thereby preventing heat from being absorbed or dissipated by the more thermally conductive core 32.

Similarly, FIG. 8 depicts multiple layers or coatings as a part of the roller, such as roller 22 or 23, in accordance with yet another embodiment of the present technique. In such an embodiment, the different layers 33 and 34 between the surface layer 31 and the core 32 can possess different thermal properties that provide for the desired thermal communication between the core 32 and the surface layer 31. For example, the intervening layers 33 and 34 may form a thermal barrier or a thermally insulating layer, such as a thermal damper, which can be used to control the temperatures in a continuous fashion.

In such embodiments, the mismatch in material properties between two adjacent layers may result in stress at the interface of the layers, which can cause delamination of these layers. To mitigate this issue, two layers can have an intermediate graded layer disposed between them, where the mechanical, thermal, electrical properties are varied discretely in a stepped manner or continuously in the intermediate graded layer so as to reduce the stresses seen within such a construction. For example, in one embodiment, the intermediate layer is composed of varying volume fractions of the two adjoining layers. Therefore, the properties of the intermediate layer can be tailored to vary in a discrete, linear or non-linear manner from one material to another material.

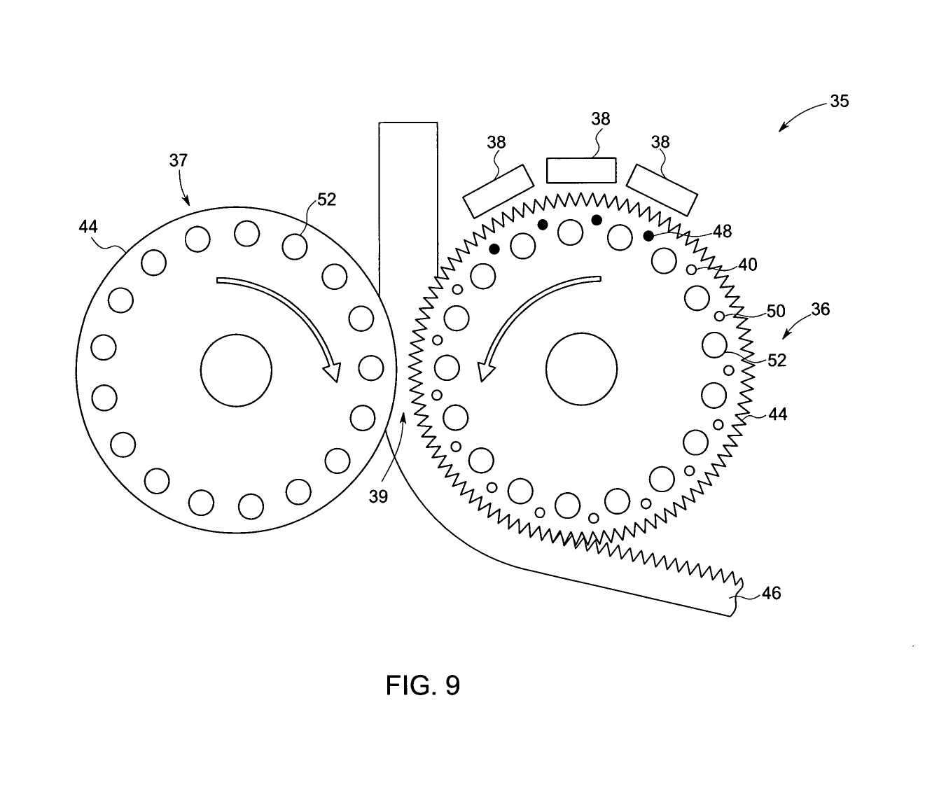

While the preceding discussion relates to passive techniques of controlling transient thermal temperatures of a polymer substrate within the nip region, active heating techniques are also possible. Indeed, as will be appreciated by those of ordinary skill in the art, the passive heating techniques discussed above may be supplemented or used in conjunction with the active heating techniques, as discussed herein, to provide additional control over the transient thermal temperatures seen in the nip region. For example, turning now to FIG. 9, a portion of an exemplary calendaring apparatus 35 for forming a textured polymeric film 46, and operating in accordance with an aspect of the present technique is illustrated. The calendaring apparatus 35, as illustrated, includes multiple induction heating coils 38 disposed proximate to the surface of a first roller 36. In the depicted embodiment, the multiple induction heating coils 38 are positioned near the nip region 39 formed by the roller assembly through which polymeric substrate is introduced. The induction heating coils are adapted to heat a limited portion of one or both rollers, such as the surface or textured portion of the rollers. The rate and depth of heating may be controlled by adjusting the current and frequency supplied to the induction-heating coils.

The calendaring apparatus 35 also includes structures 40 that are conductive to eddy current heating, being embedded within the first roller 36 such that structures 40 are proximate to but within the boundary 44 formed by the surface of the first roller 36. In the depicted embodiment, structures 40 are spaced evenly along the interior periphery of the first roller 36, and each structure has an axis which is generally parallel to the axis of the first roller 36, i.e., the axial orientation of the structures 40 is the same as that of the first roller 36. While in the illustrated embodiment, the structures 40 and the induction heating coils 38 are shown on the first roller 36, in other implementations, structures 40 and induction heating coils 38 may be similarly disposed on the second roller 37 as well. In the depicted embodiment, structures 40 and induction heating coils 38 together form a heating component that is positioned to heat the first roller 36 proximate to the nip region 39 defined by the first roller 36 and second roller 37.

In the embodiment depicted in FIG. 9, the structures 40 and induction heating coils 38 work in conjunction with each other for heating the first roller 36. In particular, the structures 40 embedded in the first roller 36 may be switched on, as shown generally by reference numeral 48, and switched off, as shown generally by reference numeral 50, based on the proximity of the structures 40 to the nip region 39.

The calendaring apparatus 35 further includes a cooling system configured for cooling the first and second rollers such that the temperature of the rollers, or different portions of the rollers, may be maintained within tight temperature constraints during rotation. In one embodiment of the present technique, the cooling system comprises cooling channels 52 embedded within either or both of the first and second rollers. As will be appreciated by those of ordinary skill in the art, the cooling system (such as in the depicted form of cooling channels 52 or in other forms) may be used in conjunction with the passive and active heating techniques discussed herein to control the temperature profile of the first and/or second rollers 36, 37 relative to the polymeric substrate. In particular, the combination of the cooling system and passive and/or active heating techniques provide a desired temperature profile of the surfaces of the roller or rollers while in contact with the polymeric substrate. The desired temperature profile, in one embodiment, has a greater temperature at the entry to the nip region than might otherwise be observed based on the temperature of the polymeric substrate alone, thereby allowing greater texture fidelity to be achieved during calendaring.

In the depicted embodiment of FIG. 9, by providing a means of heating the roller surface, the rate of heat lost by the film to the roller in the nip region decreases, and thus, the film remains above its Tg for a longer period within the nip region 39, while the pressure of the rollers acts on the film. This is because heating the roller(s) before the nip region maintains the polymeric substrate at a higher temperature for a longer duration, allowing more time at a higher temperature for the texture to be replicated with good fidelity. The longer the film is kept at a higher temperature the more is the relaxation of the polymer chains and hence greater the replication depth.

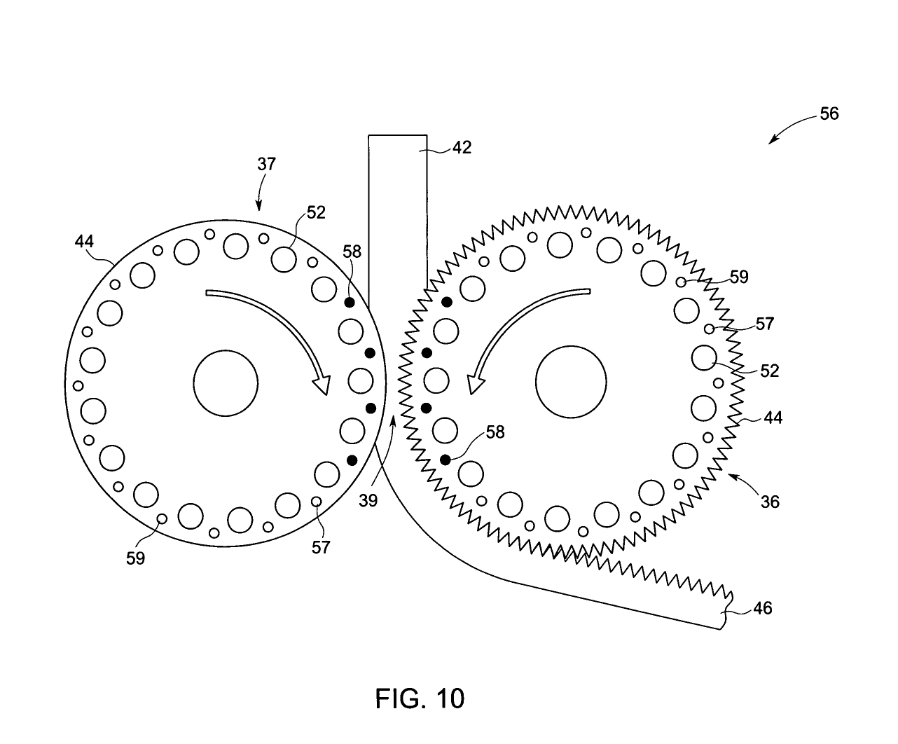

Referring now to FIG. 10, a second exemplary calendaring apparatus 56 for forming a textured polymeric film 46 is depicted. The calendaring apparatus 56 includes multiple resistive heaters 57 embedded within and extending axially through both the first roller 36 and the second roller 37. The resistive heater 57 of the first roller 36 and the second roller 37 work in conjunction with each other to heat the respective surfaces of the first and second rollers 36 and 37 as they pass through the nip region 39. The rate of heating may be controlled by adjusting the current input to the resistive heater 57. As will be appreciated by a person skilled in the art, heating the first roller 36 and the second roller 37 as they pass through the nip region 39 slows the rate at which the polymeric substrate 42 is cooled by the rollers, allowing higher fidelity replication of a pattern or texture on the roller surface onto the textured polymeric film 46. In one example, the calendaring apparatus 56 may include induction coils in place of resistive heaters. In this case, the heating would exhibit self-switching due to the increase in induction coupling (and therefore induction heating) in the vicinity of the coils near the nip region when the coils near each other. When the coils move away from each other, the coupling reduces and the corresponding heat generated also reduces.

Furthermore, in one embodiment, the resistive heaters 57 may be switched on, as shown generally by reference numeral 58, and switched off, as shown generally by reference numeral 59, based on the proximity of resistive heaters 57 to the nip region 39. The resistive heaters 57 may be selectively controlled on each of the rollers for better control of the temperature of the respective rollers. Resistive heaters 57 may be set to selectively receive electrical power via an arrangement comprising a set of commutator and contact brushes which allow power transfer between at least one rotating member and at least one stationary member (the arrangement typically resemble with the commutator and brush arrangement used in DC motors).

In addition, as explained with regard to FIG. 9, the cooling channels 52 allow cooling of the first and the second rollers, thereby allowing different portions of the first and second rollers 36 and 37 to be maintained within a desired temperature range by a combination of selective heating and cooling.

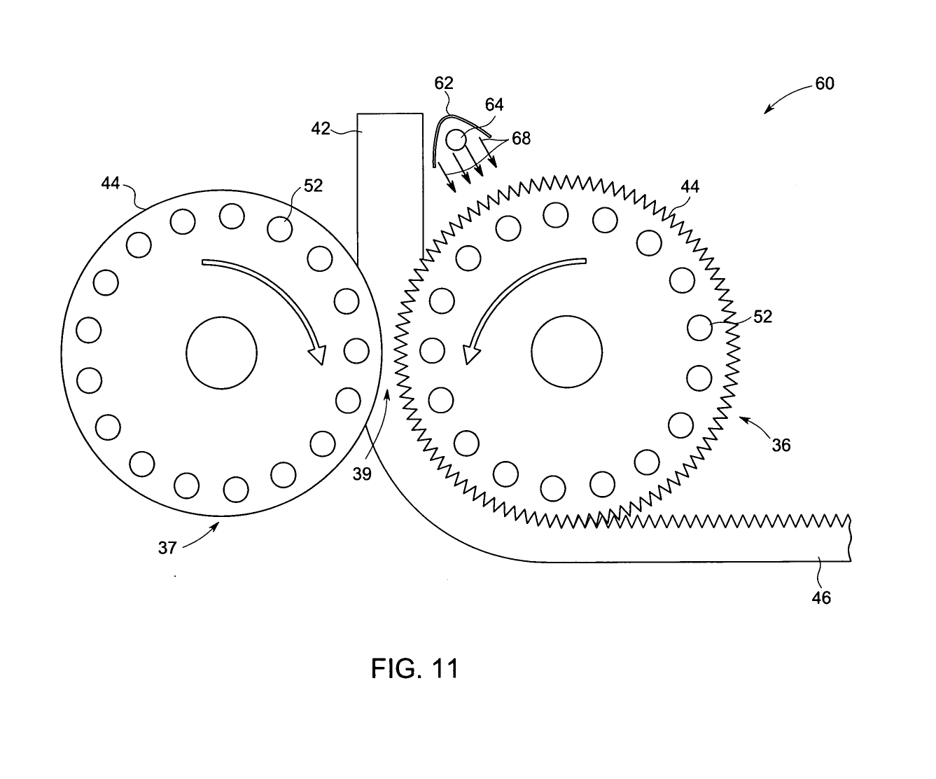

FIG. 11 depicts a further exemplary calendaring apparatus 60 for forming a textured polymeric film 46 using a radiation heating component 62, such as a radiant heater, disposed proximate to the first roller 36. The radiant heater may include but is not limited to, an infrared heater, a high intensity lamp, an arc lamp, or a laser. The radiant energy from the heat source (radiant heater) may have wavelengths in the range of about 1 nanometer (nm) to about 1 millimeter (mm) that heats objects via photon interaction, without heating the intervening air. As used herein, the term “radiation heating component” refers to the source of radiant energy as well as other associated components, such as reflectors, which are discussed in greater detail below. For the embodiment involving radiation-heating component 62, it is desirable that the roller surface is close to the radiation heating component. This will ensure efficient coupling of the heating means to the roller thereby resulting in high roller surface temperature with a compact heating unit. The roller surface can be designed to have an absorptivity to the source radiation of anywhere in the range of about 0.3 to about 1.0, with higher values of absorptivity being preferred.

For example, the depicted exemplary radiation heating component 62 includes a radiation heat source 64, such as an infrared heat source, a high intensity lamp or a laser, disposed adjacent to the first roller 36 and configured to heat the surface of the first roller 36 as it approaches the nip region 39. The radiation heat source 64 via radiation 68 heats the surface of the first roller 36 to a desired surface temperature, thereby slowing the rate at which the polymeric substrate 42 is cooled and allowing higher fidelity replication of a pattern or texture on the roller surface onto the textured polymeric film 46. While the embodiment of FIG. 11 depicts a radiation heating component 62 disposed to heat the first roller 36, a radiation heating component 62 may be used to heat the second roller 37, in addition to the first roller 36 in other embodiments.

The advantages of radiation heating are rapid heating of the roller surfaces. Also, radiation heating is suitable for heating both metal and non-metal roller surfaces as well as for heating the polymer substrate, if so desired. In addition, the power provided to the radiation heating source 64 may be modulated to adjust the heating rate.

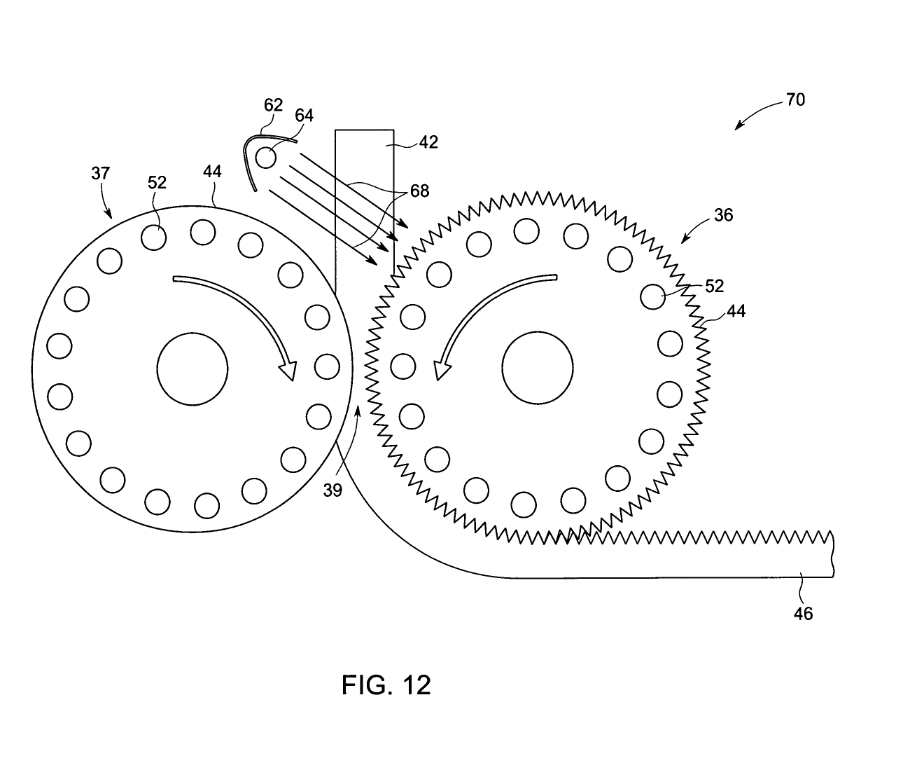

Referring now to FIG. 12, an additional exemplary calendaring apparatus 70 for forming a textured polymeric film 46 is depicted, which employs a radiation heating component 62. In the embodiment depicted in FIG. 12, the radiation heating component 62 is situated away from the first roller 36. This arrangement may be used in an environment where the radiation heating component 62 cannot be placed closer to the first roller 36 due to space constraints or other hindrances. The other components and the function of the components as previously explained remain unchanged.

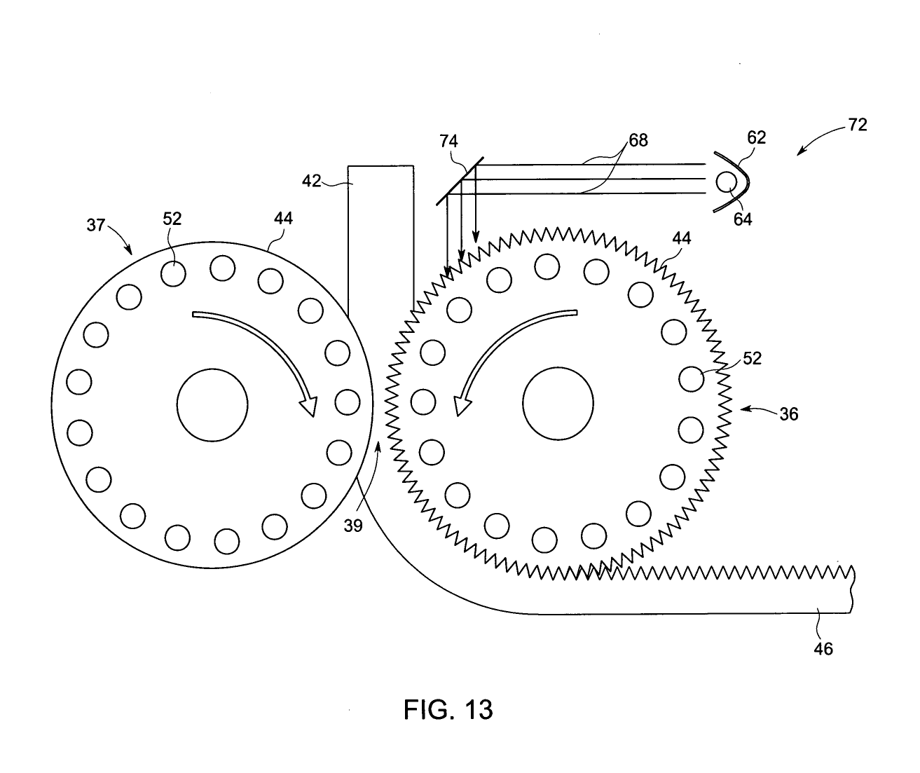

Similarly, FIG. 13 depicts an exemplary calendaring apparatus 72 for forming a textured polymeric film 46 having a radiation heating component 62 and a reflector 74. As discussed with regard to FIG. 12, the depicted embodiment of FIG. 13 allows for placement of the radiation source 64 away from the area to be heated, such as the surface of the first roller 36 as it approaches the nip region 39. In the depicted embodiment, the reflector 74 is configured to direct radiant energy 68 onto the first roller 36. In this way, the reflector 74 may be situated in a suitable position to reflect upon the desired location while the radiation source 64 may be situated farther from the rollers. In this way, through the use of reflectors, 74 such as curved reflectors (parabolic or elliptic), the useful radiant energy 68 may be significantly focused on the region to be heated. In situations, where it is desired to focus the thermal radiation to a very limited geometric area, this may be achieved through focusing optics, lenses, reflectors, and so forth. It should be noted that though a single reflector for directing the radiation rays 68 is depicted, in other embodiments multiple reflectors may be employed to direct the radiation rays 68 of one or more radiation heating components 62 on the desired region of the first roller 36 or of both the first and second rollers 36 and 37 respectively. In addition, as explained earlier, the output of the radiation heating component 62 may be adjusted to achieve a desired heating rate.

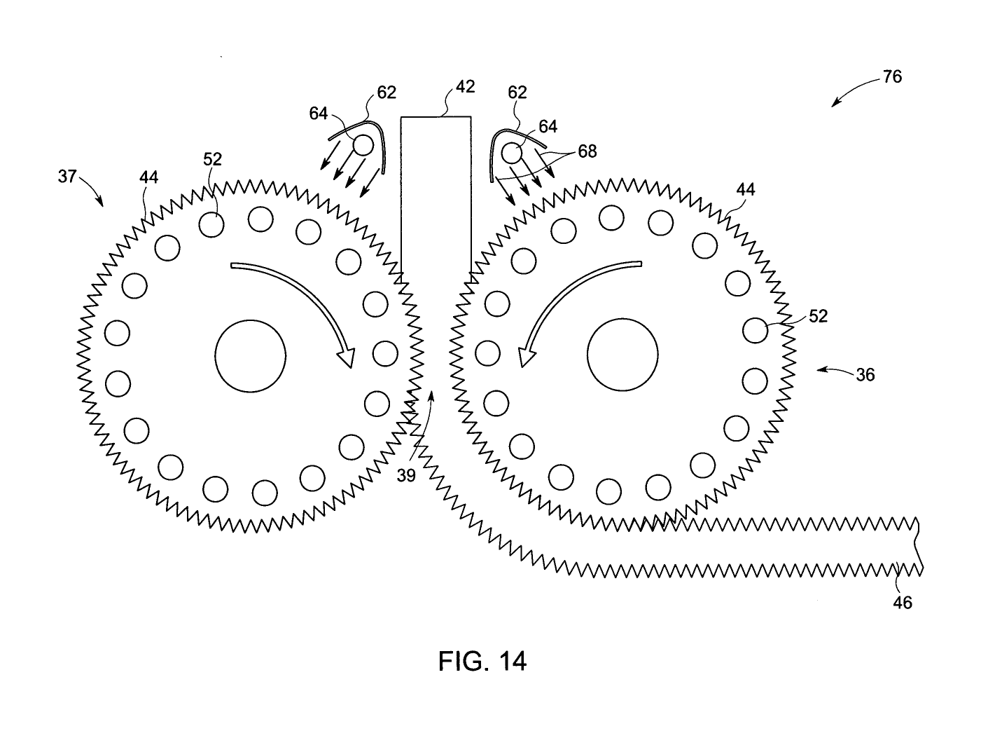

Similarly, FIG. 14 is a depiction of an exemplary calendaring apparatus 76 for forming a textured polymeric film 46 having multiple radiation heating components 62 configured to heat a limited portion of both the first and second rollers 36 and 37 as they near the nip region 39. The functions of the other components of the apparatus 76 as explained with reference in FIGS. 9-13 remain unchanged.

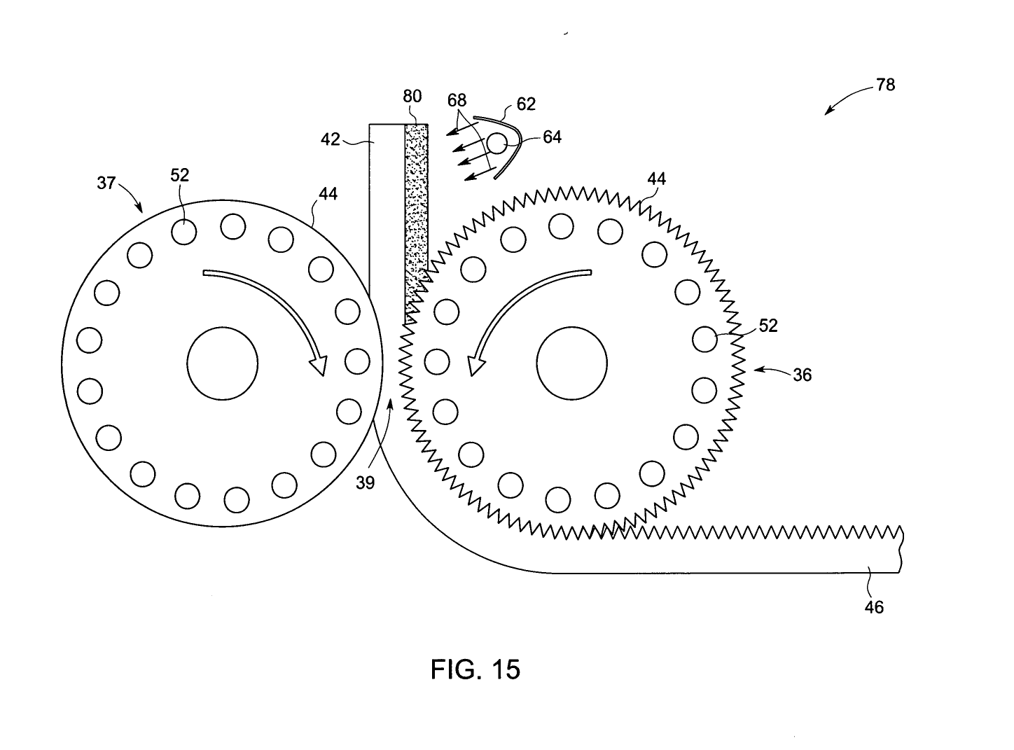

While the preceding discussions of FIGS. 11-14 has been in the context of heating the first and the second rollers 36 and 37 using the radiation heating component 62, FIG. 15 depicts an additional exemplary calendaring apparatus 78 for forming a textured polymeric film 46 using an radiation heating component 62 configured to heat the polymeric substrate 42 directly. As depicted in FIG. 15, the polymeric substrate 46 may be coated with an absorptive material 80 upon which the radiation heating component 62 directs the radiant energy 68. In this way the heating of the polymeric substrate 42 may be enhanced or otherwise made more efficient. It should be noted that the absorptive material 80 may be a single composition substance or may consist of a blend of such compositions.

In one embodiment, the heating provided by the radiation heating component 62 and the absorptive material 80 may be sufficient to melt at least a portion of the polymeric substrate 42, such as the surface to be imprinted with a texture. Alternatively, the heating may only soften the heated portion of the polymeric substrate 42, for example, by raising the temperature of the heated portion above the glass transition temperature for the material. In either case, the heating makes the heated portion of the polymeric substrate 42 more susceptible to formation of recesses and/or protrusions along the heated surface, thereby improving the fidelity of the texture replication process.

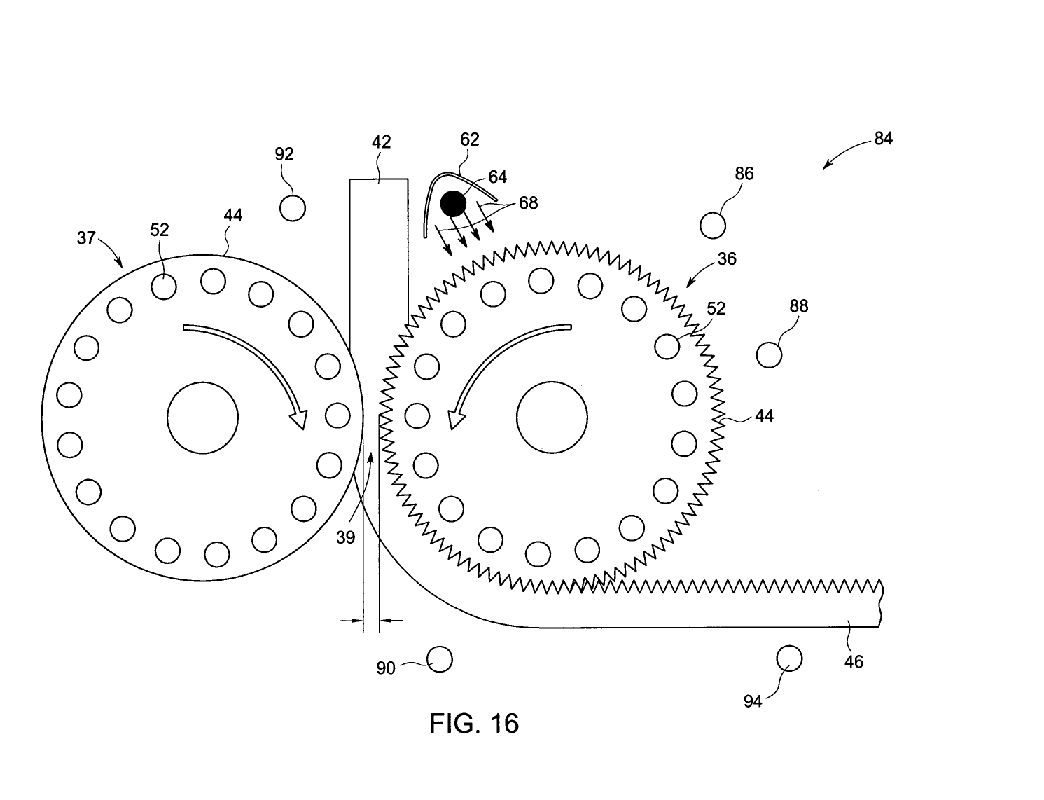

Referring now to FIG. 16, another exemplary calendaring apparatus 84 for forming a textured polymeric film 46 is depicted. The apparatus 84, as depicted, includes a radiation heating component 62 configured to heat the upper surface of the first roller 36 near the nip region 39. Multiple sensing devices (86-94) may be disposed about the apparatus 84. The sensing devices may be configured to monitor or measure various operational parameters of the apparatus 84 and/or to adjust, directly or via feedback to a control mechanism, such operational parameters. In one example, the apparatus 84 includes at least one speed sensor 86, at least one temperature sensor 88, and a roller gap sensor 90. As will be appreciated by those of ordinary skill in the art, the respective sensors may be deployed in other positions relative to the apparatus 84 than those depicted. Furthermore, the types of sensors which may be employed are not limited to those listed but may include any sensor capable of monitoring one or more operational parameters of interest and/or of adjusting the operation of the calendaring apparatus 84 based on sensed data.

In one implementation of the present technique, a speed sensor 86 monitors the speed of the first and the second rollers 36 and 37. Similarly, in the depicted embodiment, a temperature sensor 88 is located proximate to the first roller 36 for monitoring the temperature of the roller. Likewise, in this embodiment, a second temperature sensor 92 is located proximate to where the polymeric substrate 42 enters the nip region 39 to monitor the temperature of the polymeric substrate 42 entering the nip region 39. Similarly, in this embodiment, a third temperature sensor 94 is positioned proximate to where the textured polymeric film 46 exits the first and second rollers 36 and 37 to measure the temperature of the emergent textured polymeric film 46. A roller gap sensor 90, located proximate to the nip region 39, is also present in the depicted embodiment and is configured to measure the distance between the first roller 36 and the second roller 37. It may be noted that the sensors referred herein are merely illustrative and other embodiments are not limited to sensors of the types described herein or to the placement of such sensors as described in the depicted exemplary embodiment.

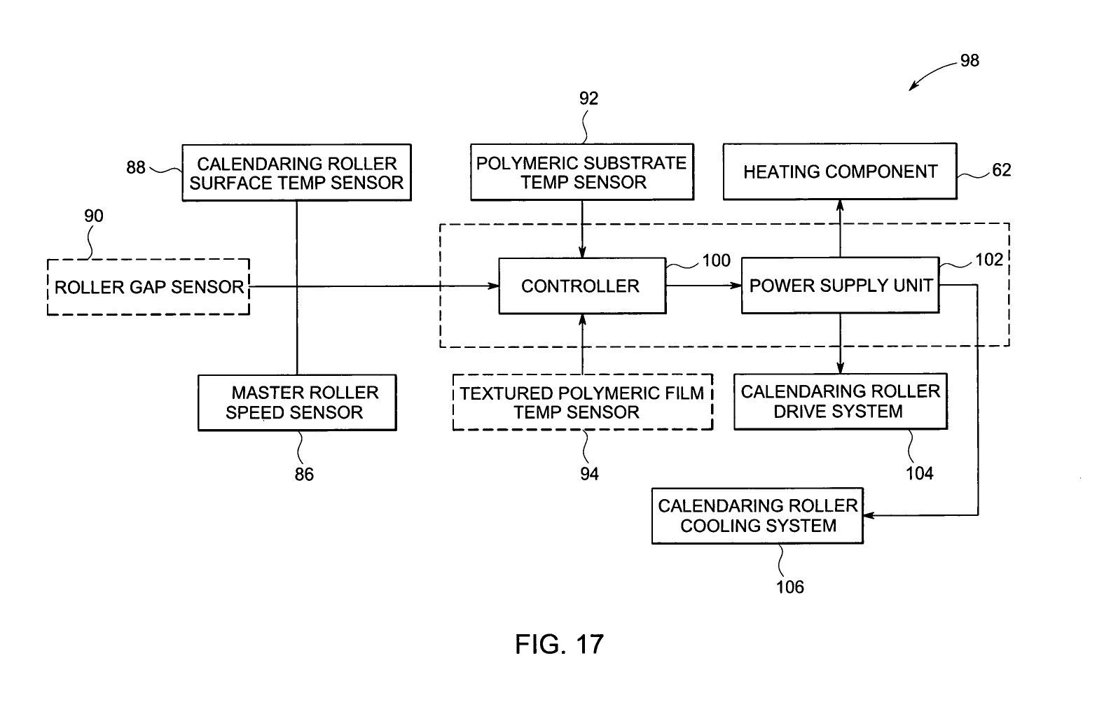

As will be appreciated by those skilled in the art, the sensors of the embodiment depicted in FIG. 16 may be configured to work in a coordinated manner. For example, referring to FIG. 17, one exemplary embodiment of a control scheme including the sensors and components described herein is depicted. In particular, FIG. 17 depicts a control system 98, for controlling various operating parameters of an exemplary calendaring apparatus as described herein. As depicted in FIG. 17 and explained previously in reference to FIG. 16, the control system 98 includes a number of sensors for monitoring various operating parameters of the calendaring apparatus. The sensors may include a roller surface temperature sensor 88, a roller gap sensor 90, a roller speed sensor 86, a polymer substrate temperature sensor 92, and/or a textured film temperature sensor 94.

Some or all the above mentioned sensors may be coupled to a controller 100, which may be adapted to monitor as well as control the various operating parameters of the calendaring apparatus based on the data provided by the above mentioned sensors. In the depicted embodiment, the power supply unit 102 provides the necessary power to the controller 100 as well as to the heating component 62. Furthermore, the power supply unit 102 also provides power to a calendaring roller drive system 104 and the calendaring cooling system 106. In the depicted embodiment, the operation of the power supply unit 102 may be controlled by the controller 100, based on the input of one or more of the temperature, roller gap, or roller speed sensors, to adjust operating parameters of the calendaring apparatus. For example, in this embodiment, the controller 100 may adjust the output of the power supply unit 102 to adjust the operation of one or more of the heating component 62, the drive system 104, or the cooling system 106.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An apparatus for forming a textured polymeric film, comprising:
a first roller and a second roller configured to cooperatively form a textured polymeric film; and
a heating component configured to heat a limited portion of at least the first roller.

2. The apparatus as recited in claim 1, wherein the limited portion comprises a surface.

3. The apparatus as recited in claim 1, wherein the heating component is configured to heat the limited portion as the limited portion approaches a nip region defined by the first roller and the second roller.

4. The apparatus as recited in claim 4, wherein the heating component is configured to heat a polymeric substrate entering the nip region defined by the first and second rollers.

5. The apparatus as recited in claim 1, wherein the heating component includes at least one of an induction heating coil, a radiation heating component, a resistive heater, or combinations thereof.

6. The apparatus as recited in claim 5, wherein the radiation heating component comprises at least one of an infrared heater, a high intensity lamp, an arc lamp, and a laser.

7. The apparatus as recited in claim 6, wherein an outer surface of the first roller comprises a high absorptivity surface with respect to a source radiation.

8. The apparatus as recited in claim 5, wherein the radiation heating component comprises at least one reflector for directing radiant energy.

9. The apparatus as recited in claim 5, comprising a controller configured to selectively operate at least one heating component based on at least one operating parameter of the first roller.

10. The apparatus as recited in claim 5, wherein the heating component comprises a plurality of resistive or induction heating coils embedded in at least the first roller.

11. An apparatus for forming a textured polymeric film, comprising:
a first roller and a second roller configured to cooperatively form a textured polymeric film, wherein at least the first roller is configured to temporarily retain and radiate heat when cooperatively forming the textured polymeric film.

12. The apparatus as recited in claim 11, wherein at least the first roller has a surface having a thermal conductivity of less than about 15 Watts per meter Kelvin.

13. The apparatus as recited in claim 11, wherein at least the first roller comprises a multi-layer coating configured to control temperature of the first roller in a continuous manner.

14. The apparatus as recited in claim 13, wherein one or more layers of the multi-layer coating act as a heat barrier and wherein an interface between two adjacent layers is graded across a region.

15. The apparatus as recited in claim 13, wherein one or more layers of the multi-layer coating comprises a material of high absorptivity with respect to a source radiation.

16. The apparatus as recited in claim 13, wherein one or more layers of the multi-layer coating comprises an oxide, a carbide, a nitride or a boride of either aluminum, titanium, silicon, chromium, magnesium or zirconium or combinations thereof.

17. The apparatus as recited in claim 13, wherein one or more layers of the multi-layer coating comprises a porous material.

18. The apparatus as recited in claim 17, wherein the porous material is formed using either a sintering, coating, sputtering, vapor deposition, fusion, casting or bonding process.

19. The apparatus as recited in claim 11, comprising a heating component configured to heat at least the first roller.

20. The apparatus as recited in claim 11, wherein at least the first roller has an absorptivity greater than about 0.3 with respect to a source radiation.

21. A control system, comprising:
a first roller and a second roller configured to form a textured polymeric film;
a heating component configured to heat a limited portion of at least the first roller;
a temperature sensing device configured to measure the temperature of at least one of the first roller, the textured polymeric film, or of a polymeric substrate from which the textured polymeric film is formed;
a cooling system configured to cool at least the first roller;
a roller drive system configured to drive at least one of the first and the second rollers; and
a controller configured to control the heating component, the cooling system, or the roller drive system based on an output of the temperature sensing device.

22. The control system as recited in claim 21, comprising a roll gap sensor configured to measure a gap distance between the first roller and the second roller and to communicate the gap distance to the controller.

23. The control system as recited in claim 21, wherein the heating component comprises at least one of an induction heating coils, a radiation heating component, or a heater cartridge.

24. The control system as recited in claim 21, wherein the controller controls the operation of the heating component, the cooling system, or the roller drive system via a power supply unit.

25. The control system as recited in claim 21,comprising a speed sensor configured to measure a speed of at least one of the first roller or the second roller and to communicate the speed to the heating component for controlling heat flux of the first and the second rollers.

26. A method for forming a textured polymeric film, comprising:
providing a polymeric substrate to a roller assembly comprising a first roller and a second roller, wherein the polymeric substrate is formed into a textured polymeric film upon passing through the roller assembly; and
controlling the temperature of at least a surface of the first roller.

27. The method as recited in claim 26, comprising measuring a temperature of the polymeric substrate, the first roller, or the textured polymeric film and controlling the roller surface temperature based upon the measured temperature.

28. The method as recited in claim 26, wherein controlling the temperature comprises at least heating the surface at or near a nip region of the roller assembly.

29. The method as recited in claim 26, wherein controlling the temperature comprises cooling at least the first roller.

30. A roller for use in a calendaring process, the roller comprising two or more layers, wherein at least one layer has a thermal conductivity of less than 15 Watts per meter Kelvin.

31. The roller as recited in claim 30, wherein the roller is configured to control temperature of the roller in a graded or continuous manner.

32. The roller as recited in claim 31, wherein the at least one layer having a thermal conductivity of less that 15 Watts per meter Kelvin acts as a heat barrier.

33. The roller as recited in claim 31, wherein the at least one layer having a thermal conductivity of less that 15 Watts per meter Kelvin comprises a high absorptivity material.

34. The roller as recited in claim 31, wherein at least one layer comprises an oxide, a carbide, a nitride or a boride of either aluminum, titanium, silicon, magnesium, chromium, or zirconium or combinations thereof.

35. The roller as recited in claim 31, wherein the at least one layer having a thermal conductivity of less that 15 Watts per meter Kelvin comprises a porous material.

36. The roller as recited in claim 35, wherein the porous material is formed using either a sintering, coating, sputtering, vapor deposition, fusion, casting or bonding process.

37. A roller for use in a calendaring process comprising two or more layers having different thermal properties, wherein a surface layer has smaller thermal diffusivity than an interior layer.

38. The roller as recited in claim 37, wherein the two or more layers are configured to control temperature of the roller in a graded or continuous manner.

39. The roller as recited in claim 38, wherein the interior layer or an intermediate layer disposed between the surface layer and the interior layer acts as a thermal barrier.

40. The roller as recited in claim 38, wherein surface layer comprises a high absorptivity material.

41. The roller as recited in claim 38, wherein one or more layers of the roller comprises an oxide, a carbide, a nitride or a boride of either aluminum, titanium, silicon, magnesium, chromium, or zirconium or combinations thereof.

42. The roller as recited in claim 38, wherein one or more layers of the roller comprise a porous material.
